(19) United States
(12) Patent Application Publication
(10) Pub. No.: US 2013/0164444 A1
(43) Pub. Date: Jun. 27, 2013

(54) MANUFACTURING METHOD FOR SURFACE-MODIFIED TITANIUM PARTICLES, DISPERSION OF TITANIUM PARTICLES, AND RESIN HAVING TITANIUM PARTICLES DISPERSED THEREIN

(71) Applicants: Shuzo Tokumitsu, Shinjuku-ku (JP); Masako Kawakami, Shinjuku-ku (JP)

(72) Inventors: Shuzo Tokumitsu, Shinjuku-ku (JP); Masako Kawakami, Shinjuku-ku (JP)

(73) Assignee: HOYA CORPORATION, Shinjuku-ku, Tokyo (JP)

(21) Appl. No.: 13/822,224

(22) PCT Filed: Jul. 22, 2011
(86) PCT No.: PCT/JP2011/066711

§ 371 Date: Mar. 11, 2013

(30) Foreign Application Priority Data
Sep. 9, 2010 (JP) 2010-202119

(51) Int. Cl. B05D 3/00

(52) U.S. Cl. CPC B05D 3/002
USPC 427/219; 106/447; 524/261; 524/264; 524/265; 524/262; 523/453; 523/456

(57) ABSTRACT

A surface-modified titania particle manufacturing method is a method for manufacturing surface-modified titania particles having crystal particles of titanium dioxide and a surface modifier that coats a surface of the crystal particles, including: [1] a first step of preparing a starting solution containing a titanalkoxide compound, an alkoxysilane, an alcohol, an acid, and water; and [2] a second step of performing heating treatment on the starting solution. Furthermore, this method preferably further includes, after the second step, [3] a third step of removing a liquid phase component in the starting solution through evaporation, by reducing a pressure around the starting solution.

### TECHNICAL FIELD

The present invention relates to a method for manufacturing surface-modified titania particles, a titania particle dispersion, and a titania particle dispersed resin. More specifically, the present invention relates to a method for manufacturing titania particles that are uniformly dispersed in a matrix resin and that can improve, for example, optical characteristics of the matrix resin, and a dispersion and a resin containing these titania particles.

### BACKGROUND ART

Conventionally, as transparent materials, glass materials are used in many cases in view of their excellent optical characteristics, thermal stability, mechanical strength, and the like.

Meanwhile, recently, plastic materials are becoming used due to their excellent molding processability, shock resistance, lightness, and the like, and are widely used in various fields such as vehicle components, signboards, displays, illumination devices, optical components, light electric components, and the like.

Furthermore, with the more widened use of plastic materials, materials having higher performances and higher functions are required. For example, when plastic materials are used as LED sealing materials, the plastic materials are required to have higher refractive indexes in order to improve light emission efficiency of the LEDs. Furthermore, also when plastic materials are used as eye glass lenses, the plastic materials are required to have higher refractive indexes in view of good appearance, lightness, and the like.

In order to provide plastic materials with higher performances, composite materials are known that are obtained by adding nanosized inorganic fine particles to the plastic materials. By adding nanosized inorganic fine particles, the plastic materials are expected to have not only improved optical performances but also improved thermal stability and mechanical strength.

However, when nanosized inorganic fine particles are dispersed in a plastic material, the inorganic fine particles are easily aggregated, and cannot be uniformly dispersed. As a result, for example, light is reflected or scattered, and the transparency of the composite material is lowered.

Thus, NPL 1 discloses a method for preparing surface-modified titania particles in which titania nanoparticles are modified with an organic functional group having a catechol group, including the steps of dissolving in advance dopamine hydrochloride or 4-tert-butylcatechol in benzyl alcohol, adding titanium tetrachloride thereto dropwise, and then heating the obtained mixture. It is disclosed that, in particular, if 4-tert-butylcatechol is used, it is dissolved in organic solvent such as tetrahydrofuran (THF).

Meanwhile, NPL 2 discloses a method for preparing surface-modified titania particles in which titania nanoparticles are modified with trioctylphosphine, including the steps of adding trioctylphosphine and lauric acid to dioctyl ether, further adding titanium tetrachloride thereto, and then heating the obtained mixture.

In both of these examples, an attempt was made to improve affinity between titania nanoparticles and plastic materials, by modifying the surface of the titania nanoparticles with a surface modifier.

However, in the case of titania nanoparticles prepared according to the approach of NPL 1, the titania nanoparticles are colored due to electron donation from the surface modifier to a Ti3d orbital of the titania nanoparticles, and, thus, these particles are not suitable for use in the optical field.

Furthermore, in the case of the approach of NPL 2, coloring of the titania nanoparticles is suppressed, but, since a temperature that is as high as 300° C. is applied as a reaction condition, the functional group may decompose, and applicable surface modifiers are limited. Phosphine oxides used as surface modifiers are not easily commercially available, and are difficult to synthesize, and, thus, it is difficult to select functional groups according to resins.

Furthermore, even if these nanoparticles can be uniformly mixed with a resin, the mixture may deteriorate due to photocatalytic activity of the titania nanoparticles.

### CITATION LIST

### Non-Patent Literature

[NPL 1] Niederberger, M. et al., Chem. Mater. 2004, 16, 1202-1208
[NPL 2] Jun, Y. et al., J. Am. Chem. Soc. 2003, 125, 15981-15985

### SUMMARY OF INVENTION

### Technical Problem

It is an object of the present invention to provide a surface-modified titania particle manufacturing method that can efficiently manufacture surface-modified titania particles having high dispersibility in a matrix such as solvent or resin materials, a titania particle dispersion in which titania particles are uniformly dispersed at high concentration, and a stable titania particle dispersed resin.

### Solution to Problem

This object is achieved by following aspects (1) to (21) of the present invention.

(1) A method for manufacturing surface-modified titania particles having crystal particles of titanium dioxide and a surface modifier that coats a surface of the crystal particles, including:

a first step of preparing a starting solution containing a titanalkoxide compound, an alkoxysilane, an alcohol, an acid, and water; and

a second step of performing heating treatment on the starting solution.

(2) The method for manufacturing surface-modified titania particles according to the aspect (1), wherein, in the first step, the starting solution is prepared by preparing a pre-solution containing the alkoxysilane, the alcohol, the acid, and the water, and, then, adding the titanalkoxide compound to the pre-solution.

(3) The method for manufacturing surface-modified titania particles according to the aspect (2), wherein, between the preparation of the pre-solution and the second step, the pre-solution or the starting solution is allowed to stand at a temperature of room temperature to 100° C. for 4 to 48 hours.

(4) The method for manufacturing surface-modified titania particles according to any one of the aspects (1) to (3), wherein the alkoxysilane is a silane coupling agent or tetraalkoxysilane.

(5) The method for manufacturing surface-modified titania particles according to the aspect (4), wherein the silane coupling agent contains aliphatic hydrocarbon having at least 4 carbon atoms or aromatic hydrocarbon.

(6) The method for manufacturing surface-modified titania particles according to the aspect (4), wherein the silane coupling agent contains polyethylene glycol bonded thereto.

(7) The method for manufacturing surface-modified titania particles according to the aspect (4), wherein the silane coupling agent contains fluorocarbon.

(8) The method for manufacturing surface-modified titania particles according to the aspect (4), wherein the silane coupling agent contains a polymerizable functional group.

(9) The method for manufacturing surface-modified titania particles according to any one of the aspects (1) to (8), wherein the alcohol is a lower alcohol having not greater than 6 carbon atoms.

(10) The method for manufacturing surface-modified titania particles according to any one of the aspects (1) to (5), wherein the acid is an inorganic acid.

(11) The method for manufacturing surface-modified titania particles according to the aspect (10), wherein the inorganic acid is a halide acid whose structural formula is represented by HX (X=Cl or Br).

(12) The method for manufacturing surface-modified titania particles according to any one of the aspects (1) to (11), further including, after the second step, a third step of evaporating a liquid phase component in the starting solution by reducing a pressure around the starting solution.

(13) The method for manufacturing surface-modified titania particles according to the aspect (12), wherein the acid can be removed by volatilization.

(14) The method for manufacturing surface-modified titania particles according to any one of the aspects (1) to (13), wherein, before preparing the starting solution in the first step, the acid is contained in an amount that provides a concentration when being dissolved in the water of 1 to 10 N.

(15) The method for manufacturing surface-modified titania particles according to any one of the aspects (1) to (14), wherein, in the starting solution, the water is contained in an amount of 1 to 5 equivalents with respect to the titanalkoxide compound and the alkoxysilane.

(16) The method for manufacturing surface-modified titania particles according to any one of the aspects (1) to (15), wherein the heating treatment is performed at a temperature of 100 to 240° C.

(17) The method for manufacturing surface-modified titania particles according to any one of the aspects (1) to (16), wherein the heating treatment is performed by microwave heating.

(18) A titania particle dispersion in which the surface-modified titania particles manufactured by the method for manufacturing surface-modified titania particles according to any one of the aspects (1) to (17) are dispersed in a liquid phase dispersion medium,

wherein, when the surface-modified titania particles are contained in an amount of 50% by mass, a transmission of light having a wavelength of 400 to 700 nm through an optical path length of 1 cm is at least 90%.

(19) A titania particle dispersed resin in which the surface-modified titania particles manufactured by the method for manufacturing surface-modified titania particles according to any one of the aspects (1) to (17) are dispersed in a matrix resin,

wherein, when the titania particle dispersed resin containing the surface-modified titania particles in a ratio of 50% by mass is shaped into a layer having a thickness of 2 mm, a transmission of light having a wavelength of 400 to 700 nm in a thickness direction is at least 70%.

(20) The titania particle dispersed resin according to the aspect (19), wherein the matrix resin is any one of a silicone-based resin, an acrylic resin, an epoxy-based resin, and an olefin-based resin.

(21) The titania particle dispersed resin according to the aspect (19) or (20), wherein the crystal particles contained in the surface-modified titania particles are titanium dioxide particles having a titanium anatase crystal structure with an average particle size of 2 to 15 nm.

### Advantageous Effects of Invention

According to the present invention, a surface modifier can be introduced at high density with a simple operation, and, thus, surface-modified titania particles having high dispersibility in solvent or resin materials can be efficiently manufactured.

Furthermore, a titania particle dispersion and a titania particle dispersed resin in which titania particles are uniformly dispersed at high concentration can be obtained. In particular, according to the titania particle dispersed resin of the present invention, a resin material having significantly improved various characteristics such as optical characteristics, thermal stability, and mechanical strength is obtained.

### BRIEF DESCRIPTION OF DRAWINGS

FIG. 1 is a flowchart showing a method for manufacturing surface-modified titania particles of the present invention.

FIG. 2 is a schematic diagram for illustrating the method for manufacturing surface-modified titania particles of the present invention.

FIG. 3 is an image obtained by observing the titania particle dispersion obtained in Example 5.

### DESCRIPTION OF EMBODIMENTS

Hereinafter, a method for manufacturing surface-modified titania particles, a titania particle dispersion, and a titania particle dispersed resin of the present invention will be described in detail with reference to a preferred embodiment shown in the appended drawings.

Surface-modified titania particles obtained by the method for manufacturing surface-modified titania particles of the present invention each have a particle of titanium dioxide and a surface modifier that modifies the surface of this particle. That is to say, the surface-modified titania particle is a core/shell particle having a core that is made of titanium dioxide and a shell that is made of a surface modifier for coating this core.

Such surface-modified titania particles are free from secondary aggregation and can be uniformly dispersed in a matrix such as solvent or resin materials. Accordingly, with use of the surface-modified titania particles, for example, a composite material can be realized that is excellent in various characteristics such as optical characteristics, thermal stability, and mechanical strength.

Hereinafter, the configuration of the surface-modified titania particles will be sequentially described.

### (Titania Particles)

In the surface-modified titania particles obtained in the present invention, titania particles corresponding to the core are crystal particles of titanium dioxide. Since titanium dioxide has a high refractive index, and can be easily formed into fine particles, it is preferable as metal oxide that is dispersed in a matrix.

The titania particles have an average particle size of preferably approximately 2 to 15 nm, more preferably approximately 3 to 12 nm. If the average particle size of the titania particles is within this range, titania particles are obtained that sufficiently exhibit optical characteristics, for example, with which the action of increasing the refractive index of the composite material is sufficiently achieved.

If the average particle size of the titania particles is lower than this lower limit value, a volume ratio of the surface modifier with respect to the particles increases, and, thus, even when the titania particles and a resin are mixed, it may be difficult to obtain the effect of improving the optical characteristics of the resin. On the other hand, if the average particle size of the titania particles is higher than this upper limit value, the dispersibility of the titania particles in solvent is lowered, and the solution becomes cloudy. Thus, it is difficult for the titania particles to be uniformly mixed in a resin.

Note that the average particle size of the titania particles can be obtained, for example, from an image obtained by observing titania particles with a transmission electron microscope (TEM) or the like.

Furthermore, the titania particles have a refractive index of approximately 2.4 to 2.7 (wavelength 550 nm) that is higher than that of commonly used resin materials, and, thus, they are useful in manufacturing a composite material having a high refractive index.

### (Surface Modifier)

In the surface-modified titania particles obtained in the present invention, a surface modifier corresponding to the shell is arranged so as to coat the surface of the titania particles.

The surface modifier is made of an organic silicon compound containing silicon atoms. Accordingly, the silicon oxide (silica) moiety where inorganic properties are dominant protects the organic functional group from the photocatalytic activity of the titania particles. As a result, deterioration and decomposition of the organic functional group are suppressed, and durability of the surface-modified titania particles is improved.

According to conventional surface-modified titania particles, since an organic functional group is directly bonded to titania particles corresponding to the core, depending on the type of organic functional group, electron donation occurs from the organic functional group to an electron orbital of the titania particles, and, thus, the optical characteristics of the titania particles may unintentionally change.

On the other hand, according to the surface-modified titania particles obtained in the present invention, the silicon oxide moiety where inorganic properties are dominant is interposed between the titania particles and the surface modifier, and, thus, the electron donation is suppressed. As a result, the optical characteristics of the titania particles do not change, and a composite material having targeted optical characteristics (e.g., transparency, high refractive index, etc.) is obtained.

Furthermore, based on the reasons described above, any organic functional group can be selected without any particular consideration of the easiness in deteriorating due to the photocatalytic activity, causing electron donation, and the like of organic functional groups. Accordingly, an optimal organic functional group can be freely selected, for example, according to a composition of a dispersion medium or a matrix resin in which surface-modified titania particles are dispersed, and the shell composition can be optimized giving priority to the dispersibility and the affinity of the surface-modified titania particles with respect to the matrix.

The surface modifier is produced as an alkoxysilane-derived structure through bonding of a silanol group, which is a hydrolyzed form of an alkoxysilane, to the surface of the titania particles. An alkoxysilane is an organic silicon compound having an alkoxy group. An alkoxysilane can form a layer of a high-density surface modifier on the surface of the titania particles through bonding of a silanol group, which is obtained by hydrolyzing an alkoxy group, to the surface of the titania particles (described later in detail). Furthermore, an alkoxysilane can achieve strong bonds mainly because a silanol group is bonded to the surface of the titania particles based on various chemical interaction such as covalent bonding, ionic bonding, hydrogen bonding, intermolecular force, or the like. Furthermore, when a silanol group is bonded toward titania particles, functional groups other than the alkoxy group are naturally oriented to the side opposite the titania particles, and have dominant effects on the properties of the surface of the surface-modified titania particles.

Examples of such an alkoxysilane include various silane coupling agents.

A silane coupling agent may have any structure as long as it is an organic silicon compound having an organic-reactive functional group (organic functional group) that reacts with and is bonded to an organic material and a hydrolyzable functional group (hydrolyzable group) that reacts with and is bonded to an inorganic material. If the silane coupling agent is used, the surface modifier can be efficiently introduced.

Note that the properties exhibited by the silane coupling agent significantly vary depending on the type of functional group, and, thus, the silane coupling agent is selected as appropriate according to the field in which the produced surface-modified titania particles are used.

For example, in order to provide dispersibility of the particles in nonpolar solvent or low-polar solvent, a silane coupling agent containing aliphatic hydrocarbon having 4 or more carbon atoms or aromatic hydrocarbon is preferably used. In this silane coupling agent, the aliphatic hydrocarbon or the aromatic hydrocarbon exhibits high affinity to nonpolar solvent or low-polar solvent, and, thus, the dispersibility of the surface-modified titania particles in such a solvent can be improved. Furthermore, such surface-modified titania particles exhibit excellent dispersibility not only in nonpolar solvent or low-polar solvent but also in various resin materials (plastic materials), in particular, various hydrocarbon-based polymers such as aliphatic hydrocarbon-based polymer, aromatic hydrocarbon-based polymer, alicyclic hydrocarbon-based polymer, and the like.

Examples of the aliphatic hydrocarbon having 4 or more carbon atoms include a butyl group, an isobutyl group, a sec-butyl group, a tert-butyl group, a pentyl group, an isopentyl group, a sec-pentyl group, a hexyl group, an isohexyl group, a heptyl group, an octyl group, an isooctyl group, a sec-octyl group, a tert-octyl group, a nonyl group, a decyl group, and the like.

Note that the aliphatic hydrocarbon having 4 or more carbon atoms more preferably has 6 or more carbon atoms. Although, if a silane coupling agent having less than 4 carbon atoms is used alone, the dispersibility of the particles in solvent may not be ensured, if it is mixed with a silane coupling agent containing aliphatic hydrocarbon having 4 or more carbon atom or aromatic hydrocarbon, the dispersibility can be ensured.

Examples of the silane coupling agent include isobutyltrimethoxysilane, n-decyltrimethoxysilane, diisobutyldimethoxysilane, n-octyltriethoxysilane, n-hexyltrimethoxysilane, n-hexyltriethoxysilane, and the like.

Meanwhile, in the aromatic hydrocarbon, a hydrogen atom may be bonded or another organic functional group may be bonded to a benzene ring. As another organic functional group bonded to the benzene ring, a hydrocarbon chain is preferable, and there is no particular limitation on the number of carbon atoms thereof.

Examples of the aromatic hydrocarbon include aryl groups such as a phenyl group and a naphthyl group, and aralkyl groups such as a benzyl group and a phenethyl group.

Examples of the silane coupling agent include diphenyldimethoxysilane, phenyltrimethoxysilane, triphenylsilanol, and the like.

Furthermore, in order to provide dispersibility of the particles in polar solvent, a silane coupling agent containing polyethylene glycol bonded thereto is preferably used. This silane coupling agent exhibits high affinity to polar solvent (high-polar solvent), and, thus, the dispersibility of the surface-modified titania particles in such a solvent can be improved.

When polyethylene glycol is bonded, an ethylene glycol chain represented by the repeating unit —(CH₂—CH₂—O)— is formed in the silane coupling agent.

Examples of the silane coupling agent include:

(MeO)₃Si—(CH₂)ₘ-(EG)ₙ (1)

where m is preferably an integer of approximately 1 to 10, n is preferably an integer of approximately 1 to 3000, MeO represents a methoxy group, and EG represents an ethylene glycol chain.

Furthermore, in order to provide dispersibility of the particles in fluorine-based solvent, a silane coupling agent containing fluorocarbon is preferably used. This silane coupling agent exhibits high affinity to fluorine-based solvent, and, thus, the dispersibility of the surface-modified titania particles in such a solvent can be improved. Furthermore, such surface-modified titania particles exhibit excellent dispersibility not only in fluorine-based solvent but also in various resin materials, in particular, fluorine-based polymers.

Note that there is no particular limitation on fluorocarbon, as long as it is an organic compound having a C—F bond, and examples thereof include chlorofluorocarbon, hydrochlorofluorocarbon, hydrofluorocarbon, and the like.

Examples of the silane coupling agent include trifluoropropyltrimethoxysilane, and the like.

In addition to the above, a silane coupling agent containing a graft-polymerizable functional group is also preferably used. Such a silane coupling agent exhibits excellent dispersibility particularly in various resin materials.

Examples of the graft-polymerizable functional group include a vinyl group represented by Formula (2) below, a (meth)acrylic group represented by Formula (3) below, an epoxy group represented by Formula (4) below, a thiol group (mercapto group) represented by Formula (5) below, and the like. Note that n≧0 in Formula (2), n≧1 in Formula (3), n≧0 in Formula (4), and n≧1 in Formula (5). Furthermore, R is a hydrocarbon group in Formula (3).

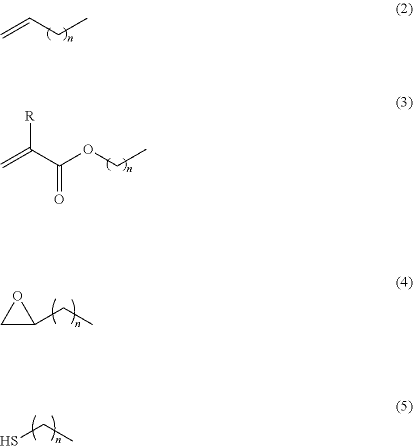

Examples of the silane coupling agent include silane coupling agents containing a vinyl group such as vinyltriacetoxysilane, vinyltris(methoxyethoxy)silane, vinyltrimethoxysilane, vinyltriethoxysilane, vinyltriisopropoxysilane, allyltrimethoxysilane, allyltriethoxysilane, or diallyldimethylsilane, silane coupling agents containing a (meth)acrylic group such as (meth)acryloxypropyltrimethoxysilane, 3-(meth)acryloxypropylmethyldimethoxysilane, or 3-(meth)acryloxypropyltriethoxysilane, silane coupling agents containing an epoxy group such as 3-glycidoxypropyltrimethoxysilane, 3-glycidoxypropyltriethoxysilane, 3-glycidoxypropylmethyldiethoxysilane, 3-glycidoxypropyldimethoxysilane, or 2-(3,4-epoxycyclohexyl)ethyltrimethoxysilane, silane coupling agents containing a thiol group such as 3-mercaptopropyltrimethoxysilane, 3-mercaptopropyltriethoxysilane, or 2,5-bis(mercaptomethyl)-1,4-dithiane, as well as silane coupling agents containing an amino group such as N-(2-aminoethyl)-3-aminopropyltrimethoxysilane or 3-aminopropyltrimethoxysilane, and the like.

Furthermore, the alkoxysilane may be a hydrolyzable silicon compound containing no organic functional group (it is referred to as a “hydrolyzable material” in this specification). Examples of the hydrolyzable material include materials that can be represented by Si—X₄ (where X is OR(R is a hydrogen atom or a hydrocarbon group), and four Xs may be the same or different), and specifically include tetraalkoxysilane such as tetramethoxysilane or tetraethoxysilane.

Such hydrolyzable materials do not generally belong to silane coupling agents, but act as an alkoxysilane constituting the shell in the present invention.

Furthermore, if the hydrolyzable material is added, the effect of increasing the degree of polymerization of a siloxane bond in silane oligomers is also expected. Accordingly, the dispersibility of the finally obtained surface-modified titania particles can be further improved.

Although the silane coupling agent and the hydrolyzable material are described above, as the silane coupling agent and the hydrolyzable material used in the present invention, the above-described materials may be used alone or in a combination of two or more.

(Surface-Modified Titania Particles)

As described above, the surface-modified titania particles of the present invention each have a titania particle and a surface modifier that coats the surface of this particle.

If the number of moles of Ti contained in the titania particles is taken as [Ti], and the number of moles of Si contained in the surface modifier is taken as [Si], the numbers of moles are set so as to have a ratio [Ti]/[Si] of preferably 8 or less, more preferably 6 or less, and even more preferably 4 or less. With this setting, the amount of surface modifier is optimized such that the surface of the titania particles can be coated as necessary and sufficiently. Note that, if the ratio [Ti]/[Si] is higher than this upper limit value, the amount of surface modifier becomes relatively too small, the surface of the titania particles cannot be sufficiently coated, and the dispersibility of the surface-modified titania particles in solvent may be lowered. On the other hand, the lower limit value is not particularly set, but it is preferably approximately 1. If the ratio [Ti]/[Si] is lower than this lower limit value, the influence of the surface modifier becomes apparent in the optical characteristics of the surface-modified titania particles, for example, it may be difficult to improve the optical characteristics (refractive index, etc.) in the composite material containing the surface-modified titania particles. That is to say, in order to improve the refractive index of the composite material to all extent possible, the ratio [Ti]/[Si] is preferably as large as possible within a range that does not impair the dispersibility of the surface-modified titania particles.

Note that the volume fraction of the core can be estimated from a result of elemental analysis on the surface-modified titania particles. If the number of moles of titania in the core is taken as Mc, and the number of moles of silicon in the shell is taken as Ms, a volume Vc of the core and a volume Vs of the shell are respectively represented by Vc=Mc×Wc/Dc and Vs=Ms×Ws/Ds. Here, Wc and Ws are the molecular weights of the core and the shell, Dc and Ds are the densities of materials forming the core and the shell. Based on the numerical equations above, the volume fraction of the core is represented by Vc/(Vc+Vs). Furthermore, a relationship between the volume fraction and the refractive index of the core can be represented by the Maxwell-Garnett model (Formulae (a) and (b) below).

$$\begin{matrix}{ɛ}_{av} = {ɛ}_{m} [ 1 + \frac{3 υ ( \frac{{ɛ}_{p} - {ɛ}_{m}}{{ɛ}_{p} + 2 {ɛ}_{m}} )}{1 - υ ( \frac{{ɛ}_{p} - {ɛ}_{m}}{{ɛ}_{p} + 2 {ɛ}_{m}} )} ] & ( a ) \\ η = \sqrt{{ɛ}_{a ∇}} & ( b )\end{matrix}$$

where

∈ₐᵥ: average dielectric constant of nanocomposite

∈ₘ: dielectric constant of matrix

∈ₚ: dielectric constant of fine particle

ν: volume fraction of fine particle

η: refractive index of nanocomposite

[Method for Manufacturing Surface-Modified Titania Particles]

Next, a method for manufacturing the above-described surface-modified titania particles (method for manufacturing surface-modified titania particles of the present invention) will be described.

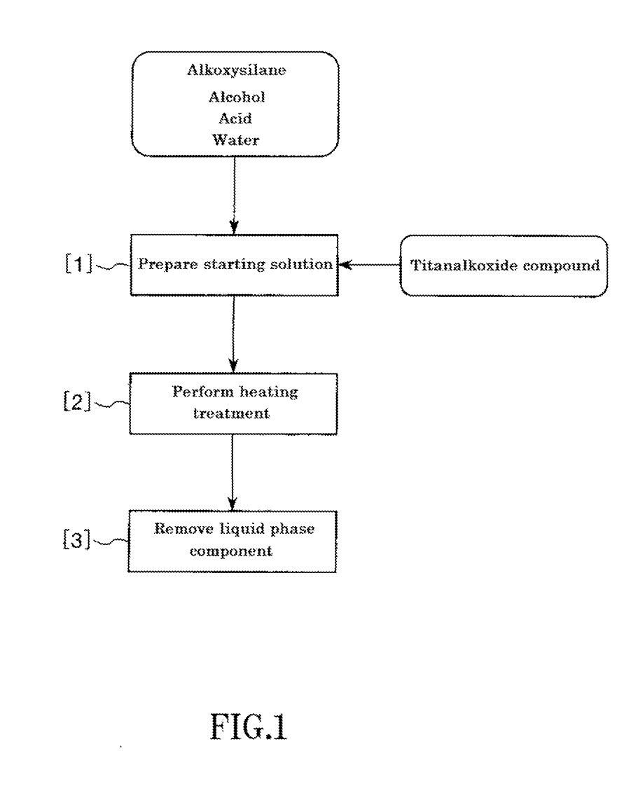

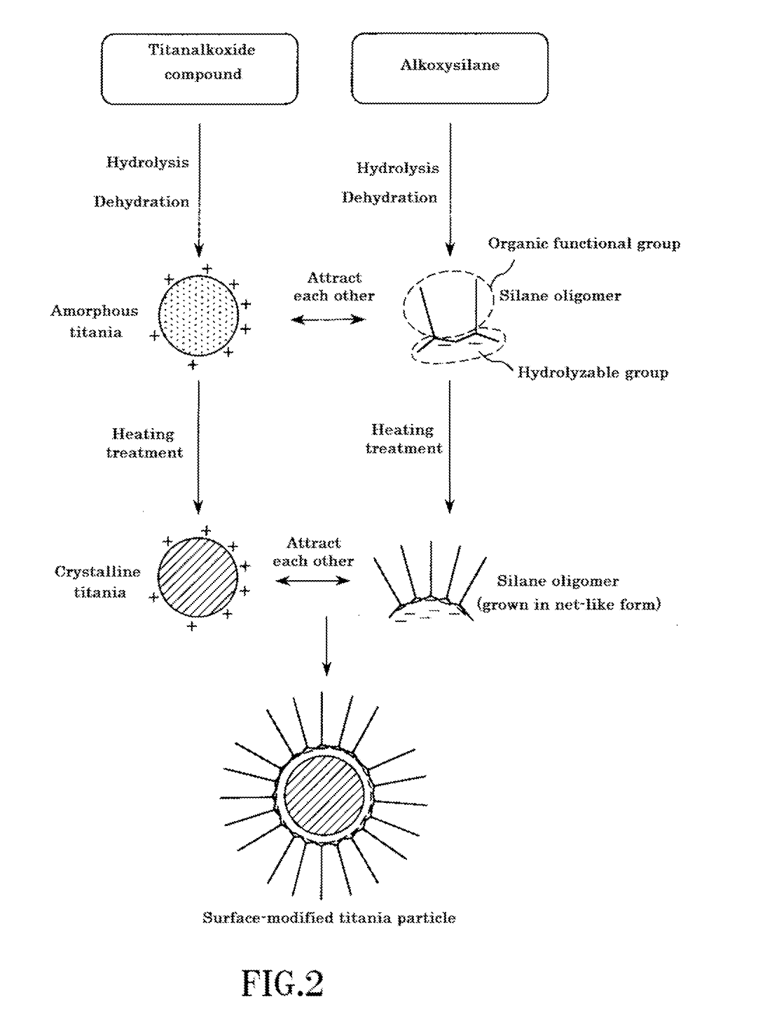

FIG. 1 is a flowchart showing a method for manufacturing surface-modified titania particles of the present invention, and FIG. 2 is a schematic diagram for illustrating the method for manufacturing surface-modified titania particles of the present invention.

This manufacturing method includes [1] a first step of preparing a starting solution containing a titanalkoxide compound, an alkoxysilane, an alcohol, an acid, and water, [2] a second step of performing heating treatment on the starting solution, and [3] a third step of removing a liquid phase component by volatilization in the starting solution on which the heating treatment was performed.

Hereinafter, each step will be sequentially described.

### [1] Preparation of a Starting Solution (First Step)

[1-1] First, a pre-solution containing an alkoxysilane, an alcohol, an acid, and water is prepared before preparing a starting solution.

In the pre-solution, an alkoxy group of the alkoxysilane changes into a silanol group through reaction with water. Furthermore, a plurality of silanol groups are dehydrated to together form silane oligomers. In silane oligomers, silanol groups are dissociated and protons are emitted, or reverse reactions thereof occur. When dissociation of the silanol groups is dominant, the silane oligomers have a negative electric charge.

Since the speed of dehydration varies according to pH, in order to stabilize the pre-solution or the starting solution that is obtained from the pre-solution, the pH of the pre-solution is preferably kept acidic, more preferably approximately at 3.5 to 5. If the pH is kept acidic, the speed of dehydration can be made low, and, thus, an excessive increase in the size of the silane oligomers, and aggregation associated with the increase can be suppressed.

The isoelectric point of silica is pH=1 to 2. Accordingly, it seems that in almost all cases in the presence of water, silanol groups are easily dissociated, and silane oligomers are stable in a state where they have a negative electric charge.

Note that, since the pre-solution contains an acid, the pH of the pre-solution is kept acidic. Accordingly, the alkoxysilane in the pre-solution can be kept stable in a state where silanol groups are dissociated, that is, silane oligomers have a negative electric charge without significant dehydration.

Examples of the water used in the pre-solution include distilled water, pure water, ultrapure water, ion-exchanged water, RO water, and the like. As described above, the water causes hydrolysis in which an alkoxy group changes into a silanol group.

Meanwhile, examples of the acid used in the pre-solution include volatile inorganic acids and organic acids, and the like, but it is preferably a volatile inorganic acids. An inorganic acid is preferable as an acid used in the present invention because its interaction with an alkoxysilane or a titanalkoxide compound that is added to the starting solution (described later) is small. Furthermore, it is possible to easily and efficiently remove an inorganic acid during the manufacture of the surface-modified titania particles while preventing the characteristics of the surface-modified titania particles from being negatively affected. That is to say, the acid used in the pre-solution is preferably volatile.

Note that preferable examples of the inorganic acid include not only nitric acid but particularly also halide acids whose structural formula is represented by HX (X=Cl or Br). Such a halide acid is particularly useful as an acid used in the present invention because its interaction with an alkoxysilane or a titanalkoxide compound is particularly small and it has relatively high volatility.

Furthermore, an alcohol is selected as solvent for the pre-solution because it provides a uniform reaction system. That is to say, an alkoxysilane is poorly soluble in water, but is soluble in alcohol, and, thus, an alcohol is used as solvent for the pre-solution, so that the reaction system can be made uniform.

Note that, in view of water solubility, interaction between the alcohol and a titania sol (described later), and the like, the alcohol used in the pre-solution is preferably a lower alcohol, more preferably a lower alcohol having 6 or less carbon atoms, and even more preferably a lower alcohol having 4 or less carbon atoms.

Specific examples thereof include methanol, ethanol, n-propanol, isopropanol, n-butanol, isobutanol, sec-butanol, tert-butanol, and the like, and these materials are used alone or in a mixture of two or more.

Among these alcohols, alcohols having a linear molecular structure, such as ethanol, n-propanol, n-butanol, and the like, are particularly preferably used. If such alcohols are used, the reaction system can be made uniform.

Furthermore, the pre-solution may contain not only these components but also any other additives (e.g., inhibitors that inhibit hydrolysis or dehydration, etc.). In this case, the additives that are used are also volatile.

Note that the acid used in the pre-solution is contained in an amount that provides a concentration when being dissolved in the water of preferably 1 to 10 N, more preferably 2 to 8 N. If the amount of acid is within this range, the pH of the pre-solution can be optimized, and a uniform and stable pre-solution can be obtained. Furthermore, in order to realize the above-described conditions, silicon halide such as trichlorosilane may be used instead of the acid. Silicon halide is quickly hydrolyzed in the pre-solution to form corresponding hydrogen halide. Furthermore, as in the case of an alkoxysilane, the hydrolyzed form is dehydrated and forms part of silane oligomers. Accordingly, similar effects can be obtained also when a silicon halide reagent is used in an amount corresponding to the above-described concentration.

Furthermore, the amount of alcohol used in the pre-solution is preferably approximately 1 to 1000, more preferably approximately 5 to 500, in a volume ratio when the amount of water is taken as 1. If the ratio between the alcohol and the water is within this range, hydrolysis of an alkoxy group in the pre-solution and uniform dispersion of an alkoxysilane in the pre-solution can be both achieved at a high level, which significantly contributes to the manufacture of a uniform and fine particle-like titania sol in the subsequent steps.

Such a pre-solution is mixed with agitation or the like, and is allowed to stand for a predetermined time at a predetermined temperature.

Specifically, the pre-solution is preferably allowed to stand at a temperature of room temperature to 100° C. for approximately 4 to 48 hours, more preferably allowed to stand at 40 to 90° C. for approximately 10 to 30 hours. Accordingly, sufficient hydrolysis can be promoted for an alkoxy group. Furthermore, the alkoxysilane hydrolyzed form can reliably react with a titanalkoxide compound (described later) without unevenness. Note that, even within the above-described temperature range, if the temperature is relatively low, the time during which the pre-solution is allowed to stand is preferably made longer, and, if the temperature is relatively high, the time is preferably made shorter.

If the pre-solution is prepared in this manner, the alkoxysilane having a reaction speed that is lower than that of the titanalkoxide compound can efficiently react in advance, and, thus, the reaction with the titanalkoxide compound (described later) can be reliably performed without unevenness. Accordingly, if a highly reactive alkoxysilane is used, the pre-solution does not necessarily have to be prepared.

[1-2] Next, the prepared pre-solution and the titanalkoxide compound are mixed to form a starting solution.

When the pre-solution and the titanalkoxide compound are mixed, the titanalkoxide compound is hydrolyzed to be aggregated in the form of particles with three-dimensional cross-linking. On the surface of the particle-like aggregates, a repulsive force acts between the aggregated fine particles due to an electrical double layer formed by the acid, and, thus, the fine particles are uniformly dispersed in the solution. Accordingly, the growth of the aggregates is inhibited, and a fine particle-like titania sol is obtained.

At that time, it seems that the polarity of the alcohol affects the state of the electrical double layer. Specifically, an alcohol is polar solvent, and it seems that significant growth of the aggregates is suppressed by the action of this polar solvent that sets the aggregates to a predetermined zeta-potential.

Accordingly, if the type of alcohol is changed, the polarity of the alcohol is also changed, and, thus, the particle size of the thus obtained titania sol can be controlled. For example, if the polarity of the alcohol is reduced, that is, an alcohol that has a relatively small relative permittivity is used, the particle size of the titania sol can be increased, and titania particles having a large particle size can be finally obtained through the steps that will be described later. On the other hand, if the polarity of the alcohol is increased, that is, an alcohol that has a relatively large relative permittivity is used, the particle size of the titania sol can be reduced, and titania particles having a small particle size can be finally obtained.

It seems that the control of the particle size of the titania sol is affected not only by the polarity of the alcohol as described above but also in a complex manner by various factors such as the pH of the starting solution, the boiling point of the alcohol, the presence or absence of the azeotrope between the alcohol and the water or the azeotropic temperature, the molecular weight, the density, and the molecular structure of the alcohol, the solubility of the alcohol in water, the solubility of the solute in the alcohol, and the like.

Based on these actions, the particle-like titania sol obtained in the starting solution has a very small particle size in a nm order. That is to say, the acid and the alcohol synergistically act, and, thus, a uniform and fine titania sol can be efficiently manufactured. The obtained titania sol is mainly made of amorphous (noncrystal) titanium dioxide.

Here, it seems that the surface of the particle-like aggregates formed from the titanalkoxide compound in the alcohol aqueous solution has a positive zeta-potential (a positive electric charge) due to the influence of the alcohol, which is protic solvent.

Meanwhile, the above-described alkoxysilane produces silane oligomers through hydrolysis and dehydration, and the silane oligomers have a negative electric charge due to ionization of hydroxyl groups. Accordingly, in the starting solution, the titania sol having a positive electric charge and the silane oligomers having a negative electric charge attract each other due to electrostatic interactions. As a result, a uniform and fine titania sol on which the silane oligomers are bonded so as to coat the surface of the titania sol is produced as the core, and silane oligomers are produced as the shell that coats the core. In this manner, core/shell particles are obtained.

The thus obtained core/shell particles are formed based on energy that is a spontaneous attractive force between the titania sol and the silane oligomers, and, thus, have a structure in which the silane oligomers are arranged at high density with no gap around the core. Accordingly, the targeted surface-modified titania particles that are obtained by performing the steps described later have extremely high dispersibility in the matrix.

Furthermore, the energy for forming such core/shell particles is based on the fact that there is an appropriate difference between the isoelectric points of a titania component contained in the titania sol and a silica component contained in the silane oligomers. That is to say, it seems that the appropriate difference between their isoelectric points generates the above-described electric charges having opposite polarities in the aqueous solution of the alcohol and the acid, which contributes to the generation of the energy for forming the core/shell particles.

The inventor found that, when an alkoxysilane and a titanalkoxide compound are caused to react with each other in the same water-soluble liquid phase, spontaneous particle growth and spontaneous particle size control are possible based on the above-described energy, and, thus, the present invention was achieved. The present invention is useful in that a manufacturing process is extremely simple without requiring complicated operations, which will be described later in detail.

Note that, since the obtained core/shell particles have a surface to which the alkoxysilane-derived organic functional group has been introduced, any more aggregation is prevented in the second and following steps.

The titanalkoxide compound used to prepare the starting solution is a compound that produces titanium oxide through hydrolysis and dehydration. Preferable examples thereof include titanium tetramethoxide, titanium tetraethoxide, titanium tetra-n-propoxide, titanium tetraisopropoxide, titanium tetra-n-butoxide, titanium tetraisobutoxide, titanium tetra-sec-butoxide, titanium tetra-tert-butoxide, and the like. These materials may be used alone or in a combination of two or more, but titanium tetraisopropoxide is preferably used in view of reactivity and the like.

The amount of titanalkoxide compound added is set such that the amount of water with respect to the total amount of the titanalkoxide compound and the alkoxysilane is preferably 1 to 5 equivalents, more preferably 2 to 4 equivalents. Accordingly, the amount of titanalkoxide compound present in the starting solution is optimized, and, thus, a uniform and fine particle-like titania sol can be more reliably manufactured.

Note that the starting solution may contain impurities and the like that are inevitably mixed therein.

### [2] Heating Treatment (Second Step)

Next, heating treatment is performed on a dispersion of the obtained particle-like titania sol. Accordingly, the particle-like titania sol crystallizes to form crystalline titania particles.

It seems that the crystalline titania particles still have a positive electric charge. Furthermore, the silane oligomers have a negative electric charge, and, thus, core/shell particles including the crystalline titania particles as the core and the silane oligomers as the shell that coats the surface of the core, that is, the surface-modified titania particles of the present invention are obtained.

Furthermore, with the heating treatment, the reaction of an alkoxysilane and a titanalkoxide compound that have not reacted yet is completed. As a result, almost all of the titanalkoxide compound is used for the manufacture of the titania particles, and almost all of the alkoxysilane is used for the manufacture of the surface modifier.

Furthermore, the silane oligomers are bonded to each other to produce larger net-like silane oligomers. As a result, the net-like silane oligomers are spread so as to enclose the titania particles, and, thus, the shell is more reliably fixed to the core.

The temperature in the heating treatment on the titania sol dispersion is preferably approximately 100 to 240° C., more preferably approximately 120 to 200° C. Accordingly, the amorphous titania sol can reliably crystallize without an excessive increase in the particle size.

Furthermore, there is no particular limitation on the time of the heating treatment, but, if the temperature is within the above-described range, the time is preferably approximately 10 to 360 minutes, more preferably approximately 20 to 200° C.

Note that the water-containing dispersion has to be heated at 100° C. or more, the heating treatment is performed at high pressure. The pressure is set as appropriate according to the temperature in the heating treatment, but it is set, for example, at approximately 200 kPa to 10 MPa.

Furthermore, the heating treatment is performed using a commonly used autoclave used for sterilization treatment, as well as a microwave high-temperature high-pressure heating apparatus, an oil bath heating apparatus, and other various ovens.

Among these apparatuses, an apparatus using microwave heating can perform uniform heating without unevenness in a relatively short time.

In this manner, a surface-modified titania particle dispersion is obtained.

### [3] Volatilization Treatment (Third Step)

Next, a liquid phase component is removed by volatilization from the obtained surface-modified titania particle dispersion. Accordingly, surface-modified titania particles, which correspond to dispersoid, can be collected.

In this manner, according to the present invention, all volatile materials may be used as a liquid phase component other than the surface-modified titania particles, which correspond to dispersoid, in the surface-modified titania particle dispersion obtained in the second step. Accordingly, after the surface-modified titania particle dispersion is obtained, targeted surface-modified titania particles can be efficiently collected by merely allowing the dispersion to stand or by promoting the removal by volatilization.

Furthermore, according to the present invention, the manufacturing process can be made significantly simple because core/shell particles can be manufactured using a single liquid phase system.

That is to say, as a conventional method for manufacturing core/shell particles, the reverse micelle method is known that uses a hydrophilic liquid and a hydrophobic liquid to manufacture core/shell particles, but this reverse micelle method inevitably uses non-volatile liquids (e.g., non-volatile acids), a large amount of surfactant, catalysts, and the like. Accordingly, after the core/shell particles are manufactured, for example, core/shell particles have to be separated and collected using various separation methods such as centrifugal separation, and the non-volatile liquids, the surfactants, and the like have to be washed and removed, that is, the manufacturing process is made extremely complicated.

On the other hand, according to the present invention, complicated operations such as these separation treatment and washing treatment are not required at all, and, thus, core/shell particles can be efficiently and easily manufactured.

There is no particular limitation on the volatilization treatment for a liquid phase component, as long as it is treatment that can volatilize a liquid phase component, and a method in which a dispersion is merely allowed to stand may be sufficient, but preferable examples of the method include heating, blowing of dry gas, drying with a desiccating agent, drying with reduced pressure, and the like. Among these methods, drying with reduced pressure is preferably used in view of efficiency and influences on the dispersoid.

Drying with reduced pressure is a drying method called reduced pressure drying, vacuum drying, or the like, and is performed with a pressure that has been reduced to be lower than atmospheric pressure (preferably, 3 kPa or lower) and a temperature that is not particularly limited but is less than 100° C. Furthermore, various evaporators are preferably used for this drying.

In this manner, the surface-modified titania particles can be collected. As necessary, the collected surface titania particles may be dispersed again in a high-affinity dispersion medium according to the type of organic functional group contained in the alkoxysilane. Accordingly, the surface-modified titania particles can be stably stored for a long period of time while suppressing deterioration of organic functional groups contained in the particles.

[Titania Particle Dispersion]

Since the surface-modified titania particles manufactured by the method for manufacturing surface-modified titania particles of the present invention have extremely high dispersibility in a matrix as described above, a high-concentration titania particle dispersion (a titania particle dispersion of the present invention) can be obtained.

The dispersion medium in which the surface-modified titania particles are to be dispersed is selected as appropriate according to the type of organic functional group contained in the alkoxysilane, and examples thereof include nonpolar solvent and low-polar solvent such as hexane, benzene, toluene, xylene, diethyl ether, chloroform, ethyl acetate, methylene chloride, decane, dodecane, and tetradecane, and polar solvent such as water, methanol, ethanol, n-propanol, isopropanol, n-butanol, sec-butanol, tert-butanol, ethylene glycol, ethylene glycol monoalkyl ether, ethylene glycol monoaryl ether, diethylene glycol, diethylene glycol monoalkyl ether, diethylene glycol monoaryl ether, propylene glycol, propylene glycol monoalkyl ether, propylene glycol monoaryl ether, various diols, monoalkyl ethers of various diols, monoaryl ethers of various diols, glycerin, glycerin derivative, polyol, propylamine, ethylene diamine, various carboxylic acids, and various polycarboxylic acids, and the like.

The titania particle dispersion of the present invention is characterized in that the optical transmission is high even when the surface-modified titania particles, which correspond to dispersoid, are contained at high concentration.

Specifically, the titania particle dispersion is characterized in that, when the content of the surface-modified titania particles is set at 50% by mass, the transmission (total light transmission) of light having a wavelength of 400 to 700 nm through an optical path length of 1 cm in the titania particle dispersion is 90% or more.

In a conventional dispersion, when the titania particles are contained as much as 50% by mass, the particles cannot be completely dispersed and are aggregated, and, thus, problems occur such as the dispersion becoming cloudy or the particles being precipitated. Accordingly, the dispersion is not appropriate as a starting material used to manufacture the titania particle dispersed resin in view of obtaining a uniform resin.

On the other hand, the titania particle dispersion of the present invention has a transmission within the above-described range even when containing the surface-modified titania particles at high concentration, and is useful, for example, as a starting material used to manufacture a uniform and high-functioning titania particle dispersed resin.

Note that the transmission is measured as defined in, for example, JIS K 7361 (method for measuring total light transmission of a plastic-transparent material). As a sample for the measurement, a quartz cell having an optical path length of 1 cm and filled with the titania particle dispersion is used.

[Titania Particle Dispersed Resin]

Since the surface-modified titania particles manufactured by the method for manufacturing surface-modified titania particles of the present invention have extremely high dispersibility in a matrix as described above, a titania particle dispersed resin (a titania particle dispersed resin of the present invention) in which titania particles at high concentration are contained in a resin material can be obtained.

There is no particular limitation on the resin material (matrix resin) used for the titania particle dispersed resin, and it is selected as appropriate according to the type of organic functional group that coats the surface of the surface-modified titania particles, the field in which the titania particle dispersed resin is used, and the like. Examples thereof include a silicone-based resin, an acrylic resin, an epoxy-based resin, an olefin-based resin, a polydisulfide-based resin, a polythiourethane-based resin, a polycarbonate-based resin, a polyamide-based resin, a polyester-based resin, a polyphenylene ether-based resin, a polyarylene sulfide-based resin, and the like, and these materials may be used alone or in a combination of two or more.

Among these resins, any one of a silicone resin, an acrylic resin, an epoxy-based resin, and an olefin-based resin is preferably used in view of transparency, mechanical properties, and the like.

Incidentally, the titania particle dispersed resin of the present invention contains the surface-modified titania particles at high concentration. Specifically, the resin is characterized in that, when the content of the surface-modified titania particles is set at 50% by mass and the resin is shaped into a layer having a thickness of 2 mm, the transmission of light having a wavelength of 400 to 700 nm in the thickness direction is 70% or more.

In a conventional composite material (composite resin), when the titania particles are contained as much as 50% by mass, the dispersibility between the particles cannot be ensured, and, thus, secondary aggregation inevitably occurs. Accordingly, the content of the titania particles has to be lowered while sacrificing the optical characteristics (high refractive index). Furthermore, as a result of the secondary aggregation, light is scattered or reflected due to the aggregates, and, thus, all the composite material realized have a low transmission.

On the other hand, the titania particle dispersed resin of the present invention has a transmission within the above-described range even when containing the surface-modified titania particles at high concentration, and is suitable, for example, for the above-described use fields. Particularly when the resin is used as an LED sealing material, since surface-modified titania particles having a relatively high refractive index have been added at high concentration to a resin material having a relatively low refractive index, a sealing material having a high refractive index can be realized. As a result, the light extraction efficiency from LED elements is improved, and the light emission efficiency from the entire LED device can be improved.

Furthermore, in the surface-modified titania particles, silane oligomers where inorganic properties are dominant are arranged at high density on the surface of the titania particles, and, thus, the organic functional group and the resin material (matrix resin) are reliably protected from the photocatalytic activity of the titania particles. Accordingly, even when the titania particle dispersed resin is used in the field such as an LED sealing material on which light is continuously irradiated, the matrix resin is prevented from being altered or deteriorating, and, thus, the light emission efficiency can be prevented from being lowered.

Furthermore, the organic functional group that is present on the surface of the surface-modified titania particles is preferably chemically bonded to the matrix resin. Accordingly, the dispersibility of the surface-modified titania particles is further improved, and the mechanical properties, the chemical properties, and the like of the titania particle dispersed resin are improved. Note that the chemical bonding refers to bonding such as covalent bonding, ionic bonding, hydrogen bonding, or the like.

Specifically, it seems that, if one of the matrix resin and the organic functional group has an Si—H bond, and the other has a C═C bond, a new bond is formed between these bonds.

Note that a silicone resin is often used as a matrix resin of the LED sealing material, and the silicone resin is cured using a curing method in which Si—H and Si—CH═CH₂ are condensed under the catalytic influence of a platinum complex. In this curing method, it seems that an Si—CH₂—CH₂—Si bond is newly formed (hydrosilylation), and cross-linking is formed between a molecule having Si—H (silicone condensate having a degree of polymerization of 4 to 10) and molecule having Si—CH═CH₂, the molecular weight increases, and the resin is cured.

Accordingly, if there is an Si—H bond or C═C bond (preferably, an allyl group) on the surface-modified titania particles, the matrix resin and the surface-modified titania particles can be more reliably chemically bonded to each other through the above-described curing process.

Note that, in the titania particle dispersed resin, the content of the surface-modified titania particles is preferably approximately 10 to 300 parts by mass, more preferably approximately 50 to 200 parts by mass, with respect to 100 parts by mass of the matrix resin.

Furthermore, the titania particle dispersed resin obtained has a refractive index of approximately 1.5 to 2.5. In the titania particle dispersed resin, the surface-modified titania particles have been added as appropriate, and, thus, the refractive index can be increased in proportion to the amount of addition compared to the case in which the matrix resin alone is contained.

Examples of the use fields of the titania particle dispersed resin include various optical components such as eye glass lenses, camera lenses, microlenses, Fresnel lenses, illumination lenses, polarizing plates, light-guiding plates, prism plates, and light-transmission screens, sealing materials that seal various optical devices such as LEDs, photodiodes, optical waveguides, solar cells, organic ELs, and optical MEM, and the like.

Among these use fields, LED sealing materials are preferably made of, for example, a silicone-based resin, an epoxy-based resin, or the like. Furthermore, eye glass lenses are preferably made of, for example, a polydisulfide-based resin, a polythiourethane-based resin, or the like.

In the description above, the method for manufacturing surface-modified titania particles, the titania particle dispersion, and the titania particle dispersed resin according to an embodiment of the present invention were described, but the present invention is not limited thereto.

For example, the method for manufacturing surface-modified titania particles according to an embodiment of the present invention may further include any additional step.

### EXAMPLES

Hereinafter, specific examples of the present invention will be described.

### 1. Manufacture of Surface-Modified Titania Particles and a Dispersion Thereof

### Example 1

### Solvent: Ethanol

First, 157 μl (0.5 mmol) of octyltriethoxysilane (OTS: manufactured by Tokyo Chemical Industry Co., Ltd.) was dissolved in 25 ml of ethanol (manufactured by Wako Pure Chemical Industries, Ltd.), and 194 μl of 2N hydrochloric acid (manufactured by Wako Pure Chemical Industries, Ltd.) was added thereto. This solution was agitated for 20 hours at room temperature to prepare a pre-solution. Then, 568 mg (2 mmol) of titanium tetraisopropoxide (TTIP: manufactured by Tokyo Chemical Industry Co., Ltd.) was added to this solution, and the obtained solution was agitated to prepare a starting solution. Note that the ratio [Ti]/[Si] was 4.

A pressurized vessel was filled with this starting solution, and was heated with a microwave heating apparatus (manufactured by Milestone General K.K.) at 140° C. for 2 hours. The reaction solution that had been cooled down to room temperature was placed in a rotary evaporator to remove a volatile material, and, thus, titania nanocrystals whose surface was modified with an octyl group were obtained as a colorless solid.

When 5 ml of toluene (manufactured by Kanto Chemical Co., Inc.) was add to the product, it was uniformly dispersed to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 2 to 3 nm.

### Example 2

### Solvent: n-propanol

Titania nanocrystals modified with an octyl group were synthesized as in Example 1, except that 25 ml of n-propanol (manufactured by Wako Pure Chemical Industries, Ltd.) was used instead of 25 ml of ethanol. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Example 3

### Solvent: 2-propanol

Titania nanocrystals modified with an octyl group were synthesized as in Example 1, except that 25 ml of 2-propanol (manufactured by Wako Pure Chemical Industries, Ltd.) was used instead of 25 ml of ethanol. The product was uniformly dispersed in 5 ml of toluene to form a white opaque solution. It was seen from a result of the powder X-ray diffraction (XRD) that the product was anatase-type titanium dioxide, and from a result of the transmission electron microscopy (TEM) that this product was composed of amorphous fine crystals each having a particle diameter of 15 to 30 nm.

### Example 4

### Solvent: n-butanol

Titania nanocrystals modified with an octyl group were synthesized as in Example 1, except that 25 ml of n-butanol (manufactured by Kanto Chemical Co., Inc.) was used instead of 25 ml of ethanol. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Example 5

### Solvent: i-butanol

Titania nanocrystals modified with an octyl group were synthesized as in Example 1, except that 25 ml of i-butanol (manufactured by Kanto Chemical Co., Inc.) was used instead of 25 ml of ethanol. The product was uniformly dispersed in 5 ml of toluene to form a solution that was somewhat significantly cloudy. It was seen from a result of the powder X-ray diffraction (XRD) that the product was anatase-type titanium dioxide, and from a result of the transmission electron microscopy (TEM) that this product was composed of spindle-shaped fine crystals each having a size of about 20 nm×10 nm.

### Example 6

### 6N Hydrochloric Acid

Titania nanocrystals modified with an octyl group were synthesized as in Example 1, except that 194 μl of 6N hydrochloric acid (manufactured by Wako Pure Chemical Industries, Ltd.) was used instead of 194 μl of 2N hydrochloric acid. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 2 to 3 nm.

### Example 7

### 1N Hydrochloric Acid

An operation was performed as in Example 1, except that a mixture of 97 μl of 2N hydrochloric acid and 97 μl of pure water (manufactured by Wako Pure Chemical Industries, Ltd.) was used instead of 194 μl of 2N hydrochloric acid. The product was uniformly dispersed in 5 ml of toluene to form a colorless transparent solution. It was seen from results of the powder X-ray diffraction (XRD) and the transmission electron microscopy (TEM) that this product was composed of amorphous noncrystal fine particles.

### Example 8

### 2N Hydrobromic Acid

Titania nanocrystals modified with an octyl group were synthesized as in Example 1, except that 200 μl of 2N hydrobromic acid was used instead of 194 μl of 2N hydrochloric acid. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 2 to 3 nm.

### Example 9

### Heating Temperature 200° C.

Titania nanocrystals modified with an octyl group were synthesized as in Example 1, except that the heating temperature was set at 200° C. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Example 10

### Heating Temperature 100° C.

Titania nanocrystals modified with an octyl group were synthesized as in Example 1, except that the heating temperature was set at 100° C. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 2 to 2.5 nm.

### Example 11

### Ratio [Ti]/[Si] of 1

Titania nanocrystals modified with an octyl group were synthesized as in Example 1, except that 628 μl of OTS and 776 μl of 2N hydrochloric acid were used. The ratio [Ti]/[Si] was 1. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Example 12

### Pressure Apparatus: Oven

Titania nanocrystals modified with an octyl group were synthesized as in Example 1, except that heating was performed using an oven instead of a microwave heating apparatus. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 2 to 3 nm.

### Example 13

### Silane Coupling Agent: Polyethylene Glycol Modification

Surface-modified titania particles were obtained as in Example 2, except that (hydroxy(polyethyleneoxy)propyl)triethoxysilane (manufactured by Gelest) was used instead of n-octyltriethoxysilane. When 5 ml of water/methanol mixed liquid (water methanol=1:1 (volume ratio)) was added to the product, it was uniformly dispersed to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 2 to 3 nm.

### Example 14

### Silane Coupling Agent: Perfluorocarbon Modification

Surface-modified titania particles were obtained as in Example 1, except that (heptafluoro-1,1,2,2-tetrahydrodecyl)triethoxysilane (manufactured by Gelest) was used instead of n-octyltriethoxysilane. When 5 ml of chloroform was added to the product, it was uniformly dispersed to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 2 to 3 nm.

### Examples 15 and 16

Surface-modified titania particles were obtained as in Example 2, except that methacryloxypropyltriethoxysilane was used instead of n-octyltriethoxysilane. The product was uniformly dispersed in 5 ml of ethyl acetate to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Example 17

Surface-modified titania particles were obtained as in Example 2, except that 3-glycidoxypropyltrimethoxysilane was used instead of n-octyltriethoxysilane. The product was uniformly dispersed in 5 ml of tetrahydrofuran to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Example 18

Surface-modified titania particles were obtained as in Example 2, except that allyltriethoxysilane was used instead of n-octyltriethoxysilane. The product was uniformly dispersed in 5 ml of toluene to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Example 19

Surface-modified titania particles were obtained as in Example 2, except that vinyltriethoxysilane was used instead of n-octyltriethoxysilane. The product was uniformly dispersed in 5 ml of dichloromethane to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Example 20

Surface-modified titania particles were obtained as in Example 2, except that 3-mercaptopropyltriethoxysilane (manufactured by Gelest) was used instead of n-octyltriethoxysilane. The product was uniformly dispersed in 5 ml of chloroform to form a colorless transparent solution. It was seen from a result of the powder X-ray diffraction (XRD) that the product was anatase-type titanium dioxide, and from a result of the transmission electron microscopy (TEM) that this product was composed of fine crystals each having a particle diameter of 5 to 8 nm.

### Comparative Example 1

First, 8.90 g of sodium di(2-ethylhexyl)sulfosuccinate, 3.60 ml of distilled water, and 0.77 g of p-toluenesulfonic acid monohydrate were added to 100 ml of xylene. This solution was agitated at room temperature until it became a uniform solution, and, thus, a reverse micelle solution was prepared.

Next, 3.78 ml of mercaptopropyltrimethoxysilane was added to this solution, and the obtained solution was agitated at room temperature for 20 hours.

Next, titanium tetraisopropoxide dissolved in n-hexyl alcohol was added dropwise to this solution. Then, the obtained solution was subjected to heating treatment with a microwave heating apparatus (“START-S” manufactured by Milestone General K.K.) at 140° C. for 2 hours.

Next, after the obtained solution was gradually cooled down, 600 ml of methanol was added thereto, and centrifugal separation treatment was performed, after which 25 ml of chloroform was added to the solution. Subsequently, methanol addition, centrifugal separation treatment, and chloroform addition were repeated five times each, and, thus, a colorless transparent solution was obtained.

### Comparative Example 2

Dopamine hydrochloride was dissolved in benzyl alcohol, titanium tetrachloride was added thereto, and, thus, a solution was prepared.

Next, the obtained solution was heated at 75° C. for 3 days to form surface-modified titania particles having a particle size of 5 nm.

Next, in order to remove a liquid phase component, centrifugal separation treatment and washing treatment were repeatedly performed. When the surface-modified titania particles that had been separated and collected were dispersed again in water, a red-brown transparent dispersion was obtained.

### Comparative Example 3

Surface-modified titania particles were obtained as in Comparative Example 2, except that 4-tert-butylcatechol was used instead of dopamine hydrochloride.

When the obtained surface-modified titania particles were dispersed again in tetrahydrofuran, a red-brown transparent dispersion was obtained.

### Comparative Example 4

Trioctylphosphine and lauric acid were added to dioctyl ether, and the obtained solution was heated at 300° C.

Next, titanium tetrachloride was added to this solution. Furthermore, titanium tetraisopropoxide (TTIP) was added thereto, and the obtained solution was heated at 300° C. for 15 minutes. Accordingly, surface-modified titania particles each in the shape of a rod having a major axis of 10 nm and a minor axis of 3 nm were obtained.

Next, in order to remove a liquid phase component, centrifugal separation treatment and washing treatment were repeatedly performed.

When the obtained surface-modified titania particles were dispersed again in toluene, a colorless transparent dispersion was obtained.

### Comparative Example 5

Acetylacetone was dissolved in n-butanol, and titanium tetrabutoxide (TTB) was added thereto dropwise. Next, a p-toluenesulfonic acid (PTSA) aqueous solution was added to the obtained solution, the solution was heated overnight at 60° C., and, thus, surface-modified titania particles having a particle size of 2 nm were obtained.

When the obtained surface-modified titania particles were dispersed again in water, a yellow transparent dispersion was obtained.

### Comparative Example 6

Titanium tetraisopropoxide was dissolved in oleic acid, and the obtained solution was heated at 110° C.

Next, a tetramethylammonium hydroxide (TMAH) aqueous solution was added to this solution, and the obtained solution was heated for 80 minutes. Accordingly, hydrolysis and dehydration of titanium tetraisopropoxide were promoted. Thus, surface-modified titania particles whose surface was coated by oleic acid were obtained.

Next, in order to remove a liquid phase component, centrifugal separation treatment and washing treatment were repeatedly performed. When the surface-modified titania particles that had been separated and collected were dispersed again in toluene, a slightly colored transparent dispersion was obtained.

### Comparative Example 7

### Silane Coupling Agent Added Later

First, 194 μl of 2N hydrochloric acid was added to 25 ml of ethanol, this solution was agitated for 20 hours at room temperature, and 568 mg (2 mmol) of TTIP was added thereto. A pressurized vessel was filled with this solution, and was heated with a microwave heating apparatus at 140° C. for 2 hours. Then, 157 (0.5 mmol) of OTS was added to this solution, and the obtained solution was agitated at room temperature for 20 hours. The reaction solution was placed in a rotary evaporator to remove a volatile material, and, thus, a colorless solid and an oil-based material were separately obtained. When 5 ml of toluene was added to the product, the oil-based material was dissolved therein, but the colorless solid was not uniformly dispersed therein. It was seen from a result of the powder X-ray diffraction (XRD) that the colorless solid was anatase-type titanium dioxide, and from a result of the transmission electron microscopy (TEM) that this product was composed of fine crystals each having a particle diameter of 2 to 3 nm.

### Comparative Example 8

### Only Pure Water

An operation was performed as in Example 1, except that 194 μl of pure water was used instead of 194 μl of 2N hydrochloric acid. When titanium tetraisopropoxide was added, a large amount of white precipitate was formed in the solution, and the material produced after heating was not uniformly dispersed in any solvent. It was seen from a result of XRD that the product was noncrystal.

### 2. Evaluation of Titania Particle Dispersion

### 2.1 Evaluation of External Appearance

External appearances of the titania particle dispersions obtained in the respective examples were observed immediately after the production (immediately after the particles were dispersed again), one day after the production, and one week after the production. The observation results were evaluated following the evaluation standard as below.

<Evaluation Standard for External Appearance>

Excellent: Colorless and transparent
Good: Slightly colored, or slightly cloudy
Fair: Somewhat significantly colored, or somewhat significantly cloudy
Poor: Significantly colored, or significantly cloudy

### 2.2 Evaluation of Transmission

Total light transmissions of the titania particle dispersions obtained in the respective examples were measured as defined in JIS K 7361.

First, the concentration of each titania particle dispersion was adjusted to 50% by mass.

Next, a quartz cell having an optical path length of 1 cm was filled with the titania particle dispersion, light having a wavelength of 400 to 700 nm was irradiated on the quartz cell, and the transmission was measured.

### 3. Evaluation of Titania Particle Dispersed Resin

The surface-modified titania particles obtained in Examples 15 to 20 were dispersed in a matrix resin, to form titania particle dispersed resins.

Note that the matrix resin used had the composition shown in Table 2. Furthermore, the concentration of the surface-modified titania particles was adjusted to 50% by mass.

Next, each titania particle dispersed resin was shaped into a layer having a thickness of 2 mm, to form a test piece.

The total light transmission of this test piece was measured as defined in JIS K 7361. Note that the light used in the measurement had a wavelength of 400 to 700 nm.

Table 1 shows the evaluation results in Examples 1 to 14, and Table 2 shows the evaluation results in Examples 15 to 20.

TABLE 1

| | | | Ex. | Ex. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|---|---|
| | | | 1 | 2 | 3 | 4 | 5 | 6 | 7 | 8 | 9 | 10 | 11 | 12 | 13 | 14 |
| Evaluation | Dispersion | Immediately | E | E | G | E | G | E | E | E | E | E | E | E | E | E |
| result | state | after being | | | | | | | | | | | | | | |
| | | dispersed again | | | | | | | | | | | | | | |
| | | 1 Day after | E | E | F | E | F | E | E | E | E | E | E | E | E | E |
| | | 1 Week after | E | E | F | E | F | E | E | E | E | E | E | E | E | E |

| | | | | | | | | | | | | | | |
|---|---|---|---|---|---|---|---|---|---|---|---|---|---|---|
| Dispersion total light | 93 | 94 | 90 | 97 | 91 | 90 | 93 | 92 | 90 | 91 | 90 | 91 | 95 | 94 |
| transmission (%) | | | | | | | | | | | | | | |

E: Excellent, G: Good, F: Fair

TABLE 2

| | | | Ex. 15 | Ex. 16 | Ex. 17 | Ex. 18 | Ex. 19 | Ex. 20 |
|---|---|---|---|---|---|---|---|---|
| Titania | Resin | Polypropylene | Good | | | | | |
| particle | material | Methacrylic resin | | Good | | | | |
| dispersed | | Epoxy resin | | | Good | | | |
| resin | | Silicone resin | | | | Good | | |
| | | Polystyrene | | | | | Good | |
| | | Polythiourethane | | | | | | Good |
| Evaluation | Dispersion | Immediately after being | Excellent | Excellent | Excellent | Excellent | Excellent | Excellent |
| result | state | dispersed again | | | | | | |
| | | 1 Day after | Excellent | Excellent | Excellent | Excellent | Excellent | Excellent |
| | | 1 Week after | Excellent | Excellent | Excellent | Excellent | Excellent | Excellent |

| | | | | | | |
|---|---|---|---|---|---|---|
| Dispersion total light transmission (%) | 93 | 93 | 93 | 92 | 92 | 91 |
| Resin total light transmission (%) | 79 | 88 | 86 | 84 | 83 | 82 |

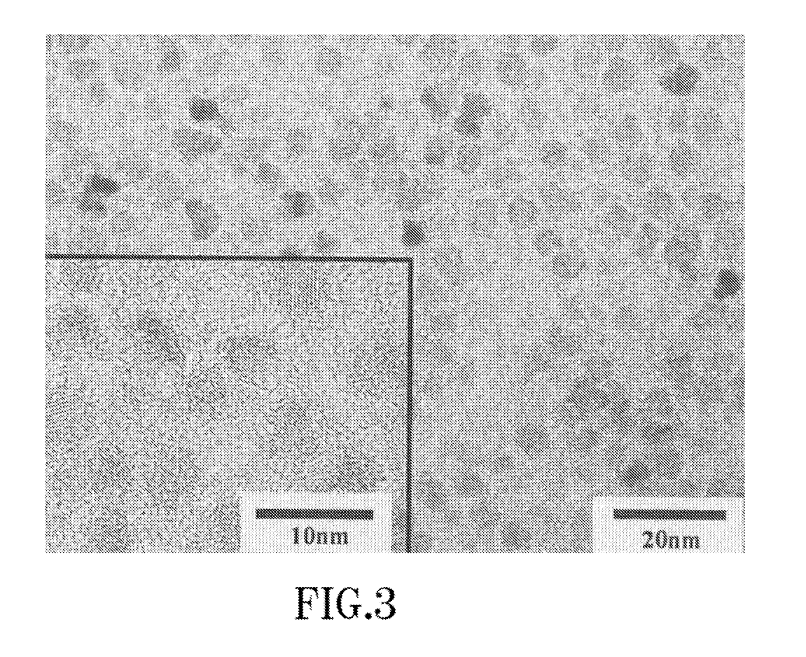

As is clear from Tables 1 and 2, according to the surface-modified titania particles obtained in each example, the dispersibility of the titania particle dispersion was relatively good, and the transmission of the dispersion was good. FIG. 3 shows an image obtained by observing the titania particle dispersion obtained in Example 4. It is seen from FIG. 3 that the surface-modified titania particles were separated from each other and each particle was substantially in a spherical shape. Particularly when ethanol, n-propanol, n-butanol, or the like was used as alcohol, this tendency was apparent. Furthermore, from the comparison of particle sizes of the surface-modified titania particles produced using these three types of alcohol, it was seen that the particle size increased as the molecular weight increased or as the relative permittivity decreased.

Meanwhile, if an acid was not added in the manufacture of the surface-modified titania particles (Comparative Example 8), the titania particle dispersion became cloudy, and the transmission of the composite resin was low.

Furthermore, if the reverse micelle method using liquid phases with different properties was used (Comparative Example 1), and if volatilization alone was not sufficient to remove a liquid phase component (Comparative Examples 2 to 6), separation treatment and washing treatment were necessary, and thus, the manufacturing process was complicated.

Furthermore, in the method in which a silane coupling agent was introduced after the production of the titania particles (Comparative Example 7), the titania particles were not uniformly dispersed in solvent. The reason for this seems to be that the titania particles aggregated before the introduction of the silane coupling agent, and the silane coupling agent and the particle surface were not bonded to each other.

Furthermore, as is clear from Table 2, if the type of silane coupling agent is selected as appropriate, a resin (composite resin) containing the titania particles was obtained as a colorless transparent resin having a high transmission.

Based on these results, it was confirmed that, according to the method for manufacturing the surface-modified titania particles of the present invention, fine crystal particles of titanium dioxide can be extremely efficiently manufactured without separation treatment or washing treatment. Furthermore, it was confirmed that the obtained surface-modified titania particles exhibit excellent dispersibility in a matrix such as solvent or resin.

### INDUSTRIAL APPLICABILITY

According to the method for manufacturing surface-modified titania particles of the present invention, a surface modifier can be introduced at high density with a simple operation, and, thus, surface-modified titania particles having high dispersibility in solvent or resin materials can be efficiently manufactured. Furthermore, according to the titania particle dispersion of the present invention, a dispersion is obtained in which titania particles are uniformly dispersed at high concentration. Furthermore, according to the titania particle dispersed resin of the present invention, a resin is obtained in which titania particles are uniformly dispersed at high concentration, and, thus, a resin material having significantly improved various characteristics such as optical characteristics, thermal stability, and mechanical strength is obtained. Accordingly, the present invention is industrially applicable.

### LIST OF REFERENCE NUMERALS

[1] First step
[2] Second step
[3] Third step

1. A method for manufacturing surface-modified titania particles having crystal particles of titanium dioxide and a surface modifier that coats a surface of the crystal particles, comprising:
a first step of preparing a starting solution containing a titanalkoxide compound, an alkoxysilane, an alcohol, an acid, and water; and
a second step of performing heating treatment on the starting solution.

2. The method for manufacturing surface-modified titania particles according to claim 1, wherein, in the first step, the starting solution is prepared by preparing a pre-solution containing the alkoxysilane, the alcohol, the acid, and the water, and, then, adding the titanalkoxide compound to the pre-solution.

3. The method for manufacturing surface-modified titania particles according to claim 2, wherein, between the preparation of the pre-solution and the second step, the pre-solution or the starting solution is allowed to stand at a temperature of room temperature to 100° C. for 4 to 48 hours.

4. The method for manufacturing surface-modified titania particles according to claim 1, wherein the alkoxysilane is a silane coupling agent or tetraalkoxysilane.

5. The method for manufacturing surface-modified titania particles according to claim 4, wherein the silane coupling agent contains aliphatic hydrocarbon having at least 4 carbon atoms or aromatic hydrocarbon.

6. The method for manufacturing surface-modified titania particles according to claim 4, wherein the silane coupling agent contains polyethylene glycol bonded thereto.

7. The method for manufacturing surface-modified titania particles according to claim 4, wherein the silane coupling agent contains fluorocarbon.

8. The method for manufacturing surface-modified titania particles according to claim 4, wherein the silane coupling agent contains a polymerizable functional group.

9. The method for manufacturing surface-modified titania particles according to claim 1, wherein the alcohol is a lower alcohol having not greater than 6 carbon atoms.

10. The method for manufacturing surface-modified titania particles according to claim 1, wherein the acid is an inorganic acid.

11. The method for manufacturing surface-modified titania particles according to claim 10, wherein the inorganic acid is a halide acid whose structural formula is represented by HX (X=Cl or Br).

12. The method for manufacturing surface-modified titania particles according to claim 1, further comprising, after the second step, a third step of evaporating a liquid phase component in the starting solution by reducing a pressure around the starting solution.

13. The method for manufacturing surface-modified titania particles according to claim 12, wherein the acid can be removed by volatilization.

14. The method for manufacturing surface-modified titania particles according to claim 1, wherein, before preparing the starting solution in the first step, the acid is contained in an amount that provides a concentration when being dissolved in the water of 1 to 10 N.

15. The method for manufacturing surface-modified titania particles according to claim 1, wherein, in the starting solution, the water is contained in an amount of 1 to 5 equivalents with respect to the titanalkoxide compound and the alkoxysilane.

16. The method for manufacturing surface-modified titania particles according to claim 1, wherein the heating treatment is performed at a temperature of 100 to 240° C.

17. The method for manufacturing surface-modified titania particles according to claim 1, wherein the heating treatment is performed by microwave heating.

18. A titania particle dispersion in which the surface-modified titania particles manufactured by the method for manufacturing surface-modified titania particles according to claim 1 are dispersed in a liquid phase dispersion medium,
wherein, when the surface-modified titania particles are contained in an amount of 50% by mass, a transmission of light having a wavelength of 400 to 700 nm through an optical path length of 1 cm is at least 90%.

19. A titania particle dispersed resin in which the surface-modified titania particles manufactured by the method for manufacturing surface-modified titania particles according to claim 1 are dispersed in a matrix resin,
wherein, when the titania particle dispersed resin containing the surface-modified titania particles in a ratio of 50% by mass is shaped into a layer having a thickness of 2 mm, a transmission of light having a wavelength of 400 to 700 nm in a thickness direction is at least 70%.

20. The titania particle dispersed resin according to claim 19, wherein the matrix resin is any one of a silicone-based resin, an acrylic resin, an epoxy-based resin, and an olefin-based resin.

21. The titania particle dispersed resin according to claim 19, wherein the crystal particles contained in the surface-modified titania particles are titanium dioxide particles having an anatase crystal structure with an average particle size of 2 to 15 nm.
